(19) United States
(12) Patent Application Publication
(10) Pub. No.: US 2014/0021323 A1
(43) Pub. Date: Jan. 23, 2014

(54) Book Sized Holder/Cradle and Associated Clamping and Positioning Mechanisms Combined into a Single Article for the Purpose of Facilitating Ergonomically Centric Human Interface With a Handheld/Pocket-sized Device While Allowing Access to the Handheld/Pocket-sized Device's Touch Screen and Selected IO Ports and Interface Buttons

(71) Applicants: Danny Wayne Bynum, McKinney, TX (US); Christopher Smith, Van Alystne, TX (US); Nicolas Adelchanow, Long Beach, CA (US)

(72) Inventors: Danny Wayne Bynum, McKinney, TX (US); Christopher Smith, Van Alystne, TX (US); Nicolas Adelchanow, Long Beach, CA (US)

(21) Appl. No.: 13/874,314

(22) Filed: Aug. 8, 2013

Related U.S. Application Data
(60) Provisional application No. 61/640,723, filed on May 1, 2012.

(51) Int. Cl. F16M 11/04

(52) U.S. Cl. CPC F16M 11/041
USPC 248/451

(57) ABSTRACT

An apparatus that provides an increased user working area and holding surface that clamps a palm-sized electronic interactive device and holds it in an outward facing direction against a larger background surface in a manner that promotes griping within the users palm in a two handed book-like interaction not otherwise achievable with the electronic device alone.

### BACKGROUND

Although there are many inventions for holding and protecting handheld/pocket-sized devices there are none which seek to somewhat counter-intuitively and purposely increase the physical interface size. The disclosed invention belongs to US Classification 361/679.56.

### SUMMARY

The following is a presentation of several embodiments of an article for manufacture that will hold/cradle a handheld/pocket-sized device (e.g. an iPhone, Droid, EVO, iPod Classic, iPod Touch, etc.) and provide a book sized structure/frame for the user to hold onto. Making a pocket-sized device larger may seem somewhat counterintuitive when first considered, but this article seeks to do just that. The main purpose of this article is to increase the mobility and handling surfaces of the handheld/pocked-size device to provide a more ergonomic book sized structure for a smaller handheld/pocket-sized device and thereby make it easier to hold onto for longer tasks such as reading or viewing photos/videos. The disclosed embodiments of this article are also unique in that they seek to combine a larger frame/structure, clamping mechanisms, and kickstand such that it will hold the handheld/pocket-sized device in place and also position it in a raised and tilted position for easy hands-free viewing.

### DRAWINGS (LIST AND TITLE)

FIG. 1 Top View of Front

FIG. 1A Perspective View Showing Mechanisms of One Embodiment

FIG. 1B Perspective View Showing Left Side Mechanism of One Embodiment

FIG. 1C Side View Showing Left Side Mechanism of One Embodiment

FIG. 1D Top View of Front—Sliding Clamp Type Embodiment

FIG. 1E Sliding Clamp Type Embodiment—Upper Claming Mechanism Close Up

FIG. 1F Sliding Clamp Type Embodiment—Parts of Upper Claming Mechanism

FIG. 2 Top View of Back

FIG. 3 Back Bottom Perspective View of One Embodiment

### DETAILED DESCRIPTION

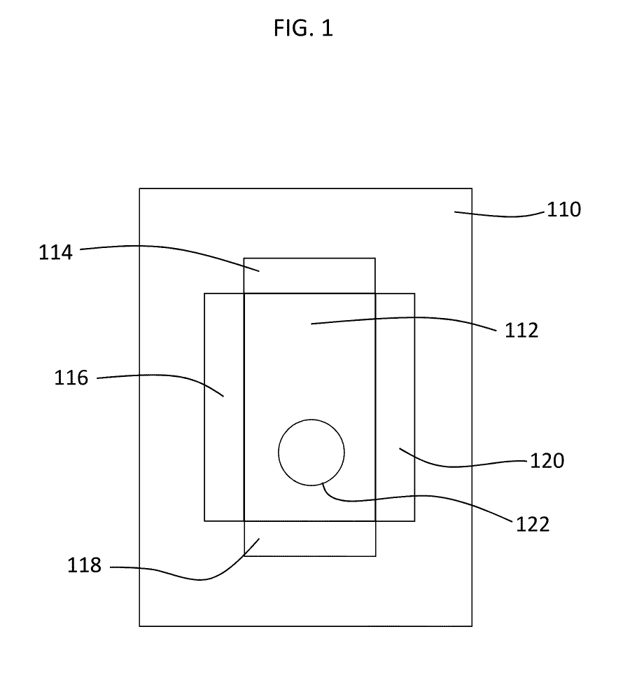

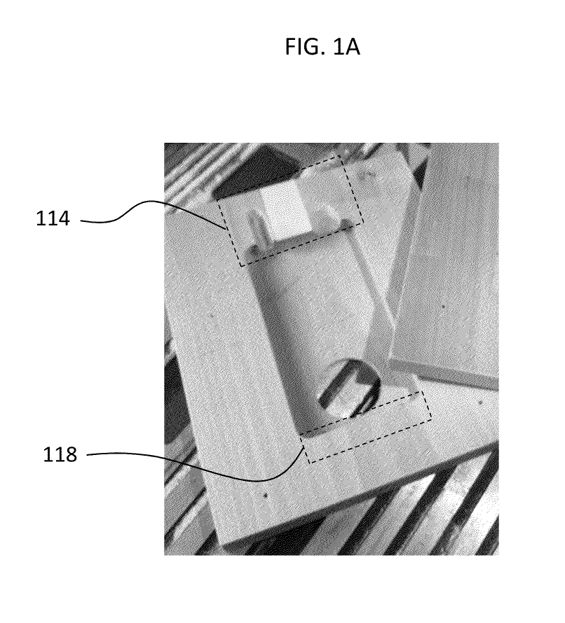

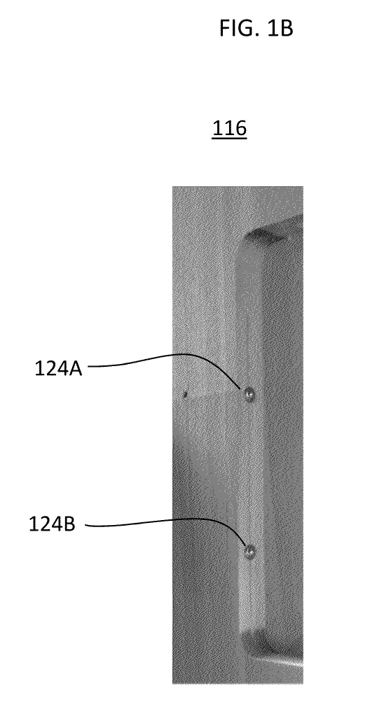

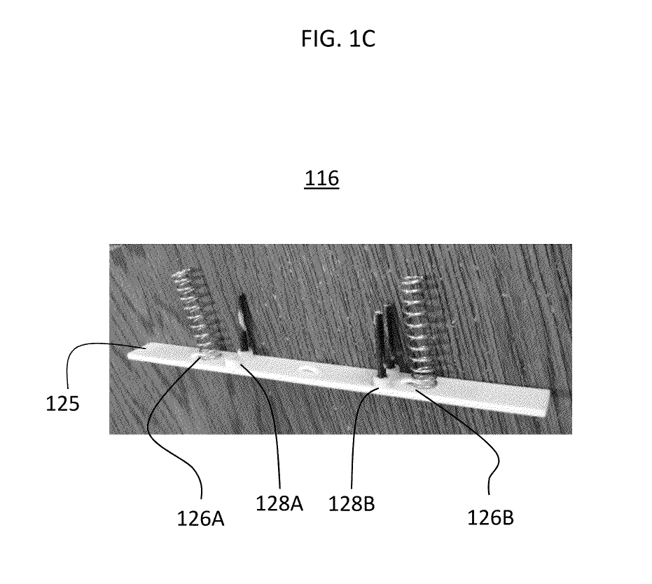

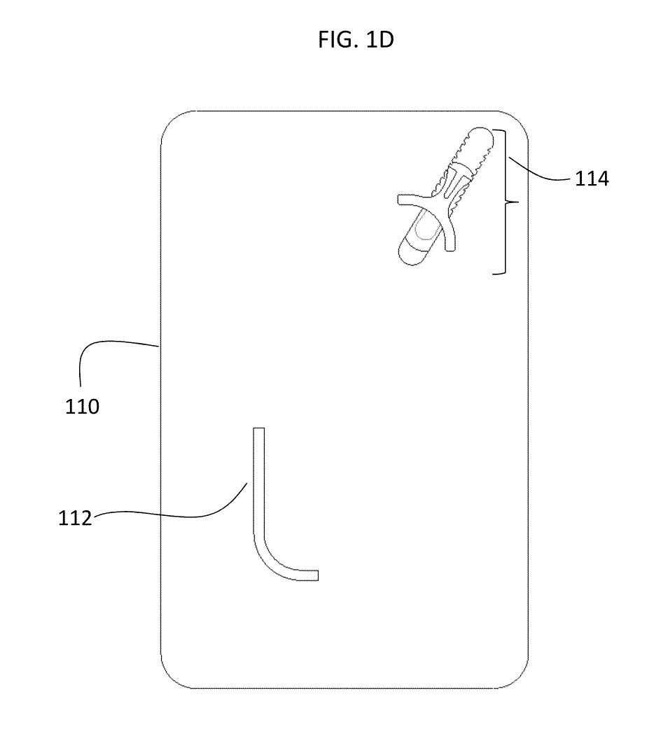

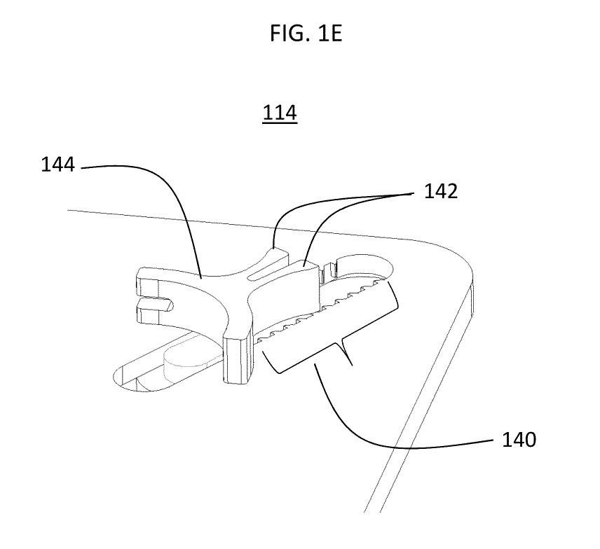

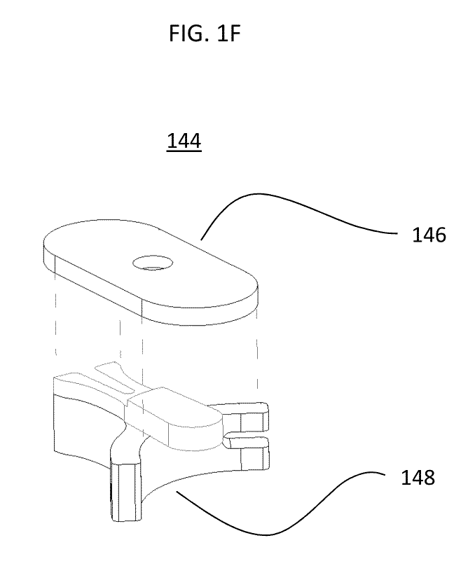

FIG. 1 shows a top view of the front. This figure shows the overall shape, layout and approximate size of one embodiment of the article disclosed. The graspable frame body 110 is the book-sized frame and main structure and allows a handheld/pocket-sized device to fit within the handheld-pocket-sized device cradle 112 while providing a structure/frame that is easier for the user to hold onto while completing longer tasks. Once placed into the graspable frame body 110 the handheld/pocket-sized device should be recessed such that it is flush or near-flush with the top surface of the graspable frame body 110. For embodiments designed with a recessed handheld/pocket-sized device the upper connections cavity 212 and lower connections cavity 214 provide the necessary space for interfacing peripherals to be plugged into the handheld/pocket-sized device even while it is inserted into the graspable frame body 110. The handheld/pocket-sized device will be held in place by clamping/holding mechanisms to include any individual or combination of the following: upper darning mechanism 114, left side clamping mechanism 116, lower clamping mechanism 118, right side clamping mechanism 120. The handheld/pocket-sized device can be easily removed/ejected by placing force on the device through the device removal port 122.

In one embodiment of the article the upper clamping mechanism 114 consists of a rigid ledge which extends approximately 1/16″ over the front surface of the cradled/inserted handheld/pocket-sized device restricting upward and outward movement and the lower clamping mechanism 118 consists of a quantity of two spring loaded bearings which fit into inherent features on the bottom of the handheld/pocket-sized device as shown in FIG. 1A. Lateral forces exerted by the bearing mechanism act to engage the ball surface into complimentary recessional features in the affixing device, thereby clamping the device into the frame/structure opening. Said recessional features are not particular to the device surfaces alone and can exist on an intermediate structure/attachment such as a device case or protecting enclosure. In the above described embodiment of the article the left side clamping mechanism 116 and right side clamping mechanism 120 are not needed and appropriately sized rigid structure would be present in their place. The use of spring loaded bearings to hold and position a handheld/pocket-sized device is a novel feature of this embodiment of the article.

Another embodiment of the article includes the left side clamping mechanism 116 and right side clamping mechanism 120 which both consist of an upper ball plunger 124A and a lower ball plunger 124B (total of four spring loaded bearings) as shown in FIG. 1B. The upper clamping mechanism 114 and lower clamping mechanism 118 are not needed and are replaced by appropriately sized rigid structure. The spring loaded bearings would be positioned opposite and congruent with matching divots on a case for a handheld/pocket-sized device.

Another embodiment of the article includes only the left side clamping mechanism 116 being used while all others are replaced by appropriately sized rigid structure to become part of the main graspable frame body 110. In this embodiment of the article the left side clamping mechanism is shown in FIG. 1C and consists of a panel 125 with upper spring 126A, lower spring 126B, upper rod 128A, and lower rod 128B. The springs 126A and 126B are compressed against the vertical sides of the handheld/pocket-sized device when said device is insertion into the cradle 112. Said springs 126A and 126B provide the tension force to hold the handheld/pocket-sized device in place. The upper rod 128A and lower rod 128B provide the inward retention forces for stabilizing the outward movement of the panel 125 and hold the panel 125 in place within the graspable frame body 110.

In another embodiment the article shown by FIG. 1D the graspable frame body 110 is a flat surface without a recessed volume to enclose the handheld/pocket-sized device. The graspable frame body 110 includes a raised border 112 near the bottom edge of which the handheld/pocket-sized device rests against. For this embodiment there is no recessed volume that the device sits in. Instead the handheld/pocket-sized device is held in place by clamping forces applied by the opposing devices of the border 112 and the upper clamping mechanism 114. Since the graspable frame body 110 is a flat surface it provides ready access to any side connections or side interfaces of the handheld/pocket-sized device. In this embodiment the upper connections cavity 212 and lower connections cavity 214 is not necessary. The graspable frame body 110 includes a hollowed void diagonally opposite to the lower border 112. This void shown in FIG. 1E provides the retaining and lateral support for the upper clamp mechanism respective to the graspable frame body 110. FIG. 1E shows a detailed view of the upper clamping mechanism 114 and its features that detail the function for this assembly. Said frame body void includes fixed gearing teeth 140 that engage with the clamp mechanism 144. The upper clamping mechanism 144 is comprised of a projecting border that contacts the corner of the handheld pocket device opposite to the bottom edge border 112. The upper clamping mechanism includes two spring levers 142 whose corner edges align and engage with the fixed gearing teeth 140 of the body void. The retainer 146 as shown in FIG. 1F attaches to the upper clamp mechanism restricting its outward motion from the graspable frame body 110. As constructed the clamp mechanism remains engaged with the graspable frame body 110 when idle. Temporary disengagement of the ratcheting clamp assembly 144 from the fixed gearing teeth 140 is achieved by compressing the spring leavers 142 allowing the clamp assembly to slide within the graspable frame body 110 void allowing different sized devices to be clamped by the fixed and motional borders.

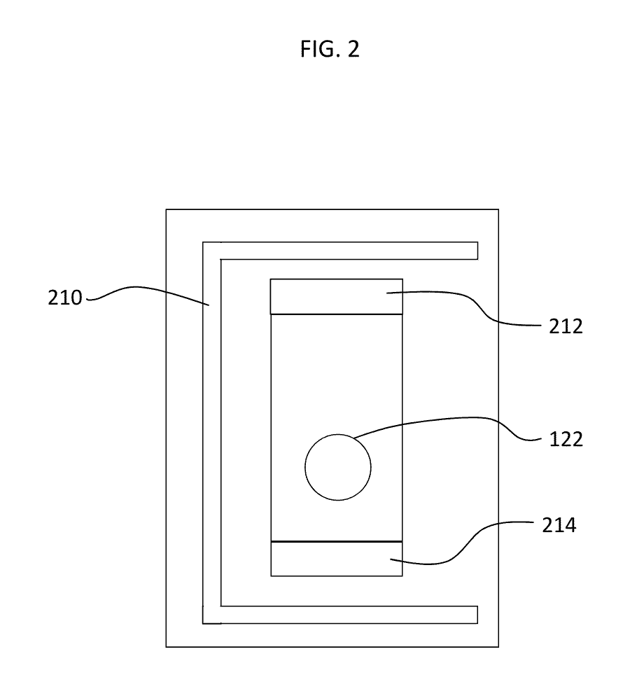

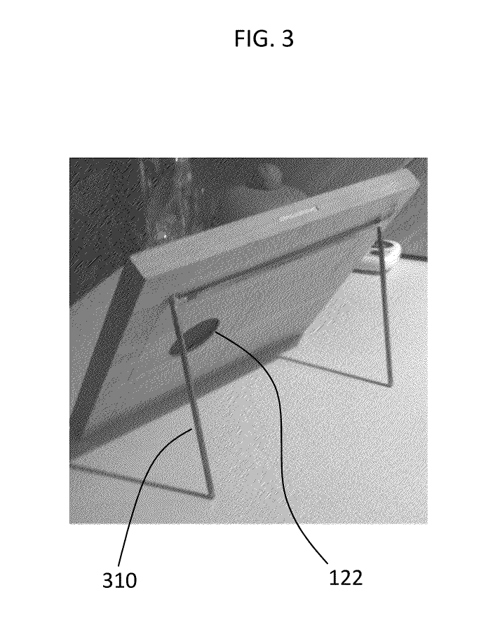

FIG. 2 shows a back view of the disclosed article. For all embodiments disclosed, an optional kickstand 310 is included, shown by FIG. 3, which props the graspable frame body 110 into the vertical position allowing said device to rest on any two sides of the graspable frame body 110 edges. Said optional kickstand 310 mechanism is affixed to the graspable frame body 110 on one end and pivots with manufactured indentions in the graspable frame body 110. The other end of the kickstand is motional and allowed to swivel outward from the graspable frame body 110 to a position predetermined by the angles set upon by the graspable frame body 110 indentations. FIG. 2 details a recessed cavity 210 allowing said kickstand to be positioned such that it is flush with the back surface when it is not in use.

FIG. 3 shows a back bottom perspective view of the disclosed article. The main purpose of this figure is to show the optional kickstand 310 being used to position the disclosed article in place. The optional kickstand 310 combined with the graspable frame body 110 allow for the handheld/pocket-sized device to be held/cradled in an elevated position and at a comfortable viewing angle. The optional kickstand 310 facilitates supporting the frame/structure upright in either portrait or landscape presentable orientations. This combination of raised height with a optional kickstand 310 is a novel feature of the disclosed article. When not in use the optional kickstand 310 can be placed in the kickstand cavity 214 such that the optional kickstand 310 is flush with the back surface of the graspable frame body 110. The optional kickstand 310 and optional kickstand recess 210 may not be present on certain embodiments of the disclosed article.

### REFERENCE NUMERALS (LIST AND TITLE)

110 Graspable Frame Body

112 Handheld-Pocket-Sized Device Cradle

114 Upper Clamping Mechanism

116 Left Side Clamping Mechanism

118 Lower Clamping Mechanism

120 Right Side Clamping Mechanism

122 Device Removal Port

124A Upper Ball Plunger

124B Lower Ball Plunger

125 Panel

126A Upper Spring

126B Lower Spring

128A Upper Rod

128B Lower Rod

140 Fixed Gearing Teeth

142 Spring Arms

144 Upper Clamp Mechanism

146 Slide Retainer

210 Kickstand Recess

212 Upper Connections Cavity

214 Lower Connections Cavity

310 Optional Kickstand

### OPERATION

Before operation of the disclosed article the user must insert a handheld/pocket-sized device into the graspable frame body 110. The handheld/pocket-sized device will need to be tilted in different orientations prior to insertion in various embodiments of the article. For the mechanisms described in FIG. 1A the handheld/pocket-sized device will need to be tilted down from the top and then inserted under the upper clamping mechanism 114 (which is extending out approx 1/16″ beyond the front face of the handheld/pocket-sized device) and then the bottom pressed down until the ball plungers snap into place.

For the mechanism described in FIG. 1B the handheld/pocket-sized device should just be snapped into place being positioned directly parallel with the front of the graspable frame body 110.

For the mechanism described in FIG. 1C the handheld/pocket-sized device will need to be tilted down on the left side and then inserted into the handheld-pocket-sized device cradle 112. With the left side tilted and inserted the user must then press on the right side of the device to overcome the spring force and then press down on the right side once the panel 125 has been displaced enough to allow for sufficient space in the handheld-pocket-sized device cradle 112.

Once the handheld/pocket-sized device is inserted the graspable frame body 110 the user may then commence to hold the larger and more ergonomic book-sized outer structure and complete longer tasks that are more convenient with such a larger sized structure to hold onto. At some time it may be beneficial for the user to tilt the kickstand 310 out of the kickstand recess 210 so that the handheld/pocket-sized device may be positioned for hands free viewing (e.g. photos, videos, etc). With the kickstand invoked it may also be useful for the user to pair a Bluetooth keyboard and/or mouse and/or other human interface device with the handheld/pocket-sized device to allow for ease of typing or other functions that would normally be carried out with touch screen interface.

1) A human interfacing ergonomically centric holding surface for a handheld electronic device comprising:
A frame capable of supporting the handheld electronic device in the direction normal to the user's viewing plane, said handheld electronic device being easily installed into or removed from said frame, said frame being of monolithic construction, said frame construction allowing for clamping and positioning mechanisms to be attached to said frame, said frame providing an extension of the handheld electronic device interaction plane whereby adding spacing such that it is facilitates a user to gripping said frame with two hands and utilize two thumbs.
A laterally moveable mechanism that is integrated with said frame, said mechanism applying compressive forces on the outside of the device thereby holding and positioning the handheld electronic device and preventing additional movement once set.
A raised boss feature positioned opposite of said mechanism, making contact with said electronic device providing a buttress support to resist lateral and forward facing movement.

2) A human interfacing ergonomically centric, recessed volume holding with ball spring support, surface for a handheld electronic device comprising:
A frame capable of supporting the handheld electronic device in the direction normal to the user's viewing plane, said handheld electronic device being easily installed into or removed from said frame, said frame being of monolithic construction, said frame construction allowing for clamping and positioning mechanisms to be held to said frame, said frame providing an extension of the handheld electronic device interaction plane whereby adding spacing such that it is facilitates a user to gripping said frame with two hands and utilize two thumbs.
A recessed cavity in the face of said surface having lesser the volume of said electronic device, such that the device fits into the cavity of the recession aligning flush with the face of the said surface.
The rim of said recession includes an outward lip of material of which provides a redirection of compressive forces, restricting upward and outward movement and wedging the electronic device when laid into the recession cavity.
A spring loaded ball plunger mechanism that is integrated with said frame, said mechanism applying outward directing compressive forces on the outside of the device thereby holding and positioning the handheld electronic device and preventing additional movement once set.

3) A human interfacing ergonomically centric, recessed volume holding with lateral support, surface for a handheld electronic device comprising:
A frame capable of supporting the handheld electronic device in the direction normal to the user's viewing plane, said handheld electronic device being easily installed into or removed from said frame, said frame being of monolithic construction, said frame construction allowing for clamping and positioning mechanisms to be held to said frame, said frame providing an extension of the handheld electronic device interaction plane whereby adding spacing such that it is facilitates a user to gripping said frame with two hands and utilize two thumbs.
A recessed cavity in the face of said surface having lesser the volume of said electronic device, such that the device fits into the cavity of the recession aligning flush with the face of the said surface.
The rim of said recession includes an outward lip of material of which provides a redirection of compressive forces, restricting upward and outward movement and wedging the electronic device when laid into the recession cavity.
A spring loaded wall bracketed mechanism that is integrated with said frame, said mechanism applying outward directing compressive forces on the outside of the device thereby holding and positioning the handheld electronic device and preventing additional movement once enacted.
